(19) United States
(12) Patent Application Publication
(10) Pub. No.: US 2018/0045344 A1
(43) Pub. Date: Feb. 15, 2018

(54) Plumbing Apparatus for Connecting a Tail Piece to a Waste Pipe

(71) Applicant: TOMLIN INDUSTRIES (2000) INC., Waterloo (CA)

(72) Inventor: Jean-Louis CLOUTIER, Mississauga (CA)

(73) Assignee: TOMLIN INDUSTRIES (2000) INC., Waterloo (CA)

(21) Appl. No.: 15/674,996

(22) Filed: Aug. 11, 2017

Related U.S. Application Data
(60) Provisional application No. 62/373,530, filed on Aug. 11, 2016.

(51) Int. Cl. F16L 21/00; E03C 1/14; E03C 1/20; F16L 21/04

(52) U.S. Cl. CPC F16L 21/007; F16L 21/04; E03C 1/14; E03C 1/20

(57) ABSTRACT

A plumbing apparatus for connecting a tail piece to a waste pipe is provided. The apparatus comprises a body having a top flanged end including an inlet configured for receiving the tail piece, a bottom end having an outlet for receiving the waste pipe, and a channel extending between the inlet and outlet. A seal extends about the channel for forming a watertight seal between the tail piece and the waste pipe. A plate is secured to the top flanged end for securing the apparatus to the floor above the waste pipe, may be removable to facilitate post-installation maintenance, and may have an off-center opening to fit various waste pipe configurations. The apparatus is useful for installing plumbing fixtures such as bathtubs, particularly where there is no access from underneath such as in already built homes.

### RELATION TO PRIOR APPLICATIONS

This application claims priority from U.S. Provisional Application No. 62/373,530, filed on Aug. 11, 2016 and the contents of which are herein incorporated by reference in their entirety.

### FIELD OF THE INVENTION

The present specification relates generally to a plumbing apparatus, and more specifically to a plumbing apparatus for connecting a tail piece to a waste pipe.

### BACKGROUND OF THE INVENTION

Buildings such as residential structures and homes generally include a waste system having a network of waste pipes for removing waste water from the structure. For example, in a typical bathroom, waste pipes are used to remove water from various plumbing fixtures such as sinks, toilets, bath tubs, etc. The waste pipe often extends through the walls of the building and ends in an opening in the floor where a fixture is intended to be installed. Plumbing fixtures generally have a tail piece through which waste water is collected and exits the fixture. The tail piece of the fixture is then connected to the waste pipe such that the waste water is transferred from the tail piece into the waste pipe.

A plumbing apparatus which connects a tail piece to a waste pipe typically contains a nut or fastener that needs to be tightened once the tail piece is inserted into the waste pipe, in order to have a sealing connection therebetween. A problem arises when replacing or installing a plumbing fixture where access to tighten the nut or fastener is not possible. This is the case, for example, where a bathtub, such as an island bathtub, needs to be installed in a house that has been already built. In this case there is no access to the apparatus from below. It is therefore necessary to destroy the ceiling of the floor below the waste pipe in order to provide access to the apparatus from the waste pipe side so that the nut or fastener may be tightened to effect a seal between the tail piece and waste pipe.

### SUMMARY OF THE INVENTION

In one aspect of the present invention, there is provided a plumbing apparatus for connecting a tail piece to a waste pipe. The plumbing apparatus comprises a body having a top flanged end having an inlet configured for receiving the tail piece; and a bottom end having an outlet opposite the inlet, the outlet configured for receiving the waste pipe. The body has a channel formed by an inner wall thereof, the channel extending between the inlet and the outlet. The apparatus further comprises a seal extending about the channel for forming a watertight seal between the tail piece and the waste pipe when the tail piece is inserted through the inlet and into the waste pipe; and stop means disposed at the inner wall for stopping the waste pipe when the waste pipe is inserted into the channel via the outlet.

In one embodiment, the stop means comprises a stop ring.

In one embodiment the plumbing apparatus further comprises a plate secured to the top flanged end for mounting the plumbing apparatus to a floor over the waste pipe. The plate has an opening surrounding at least a portion of the top flanged end and providing access to the inlet so that the tail piece may be inserted into the inlet.

In one embodiment, the plate is removably secured to the top flanged end.

In one embodiment, the plate opening is located off-center with respect to the plate.

In one embodiment, the plate is oval in shape.

In one embodiment, the plate contains at least one slot for permitting wet concrete therethrough for securing the plate onto a floor.

In one embodiment, the plate contains at least one body hole for receiving a fastener to secure the plate to the top flanged end.

In one embodiment, the plate contains at least one mounting hole for receiving a fastener to secure the plate to the floor over the waste pipe.

In one embodiment, the top flanged end comprises a taper section providing a slope from an outer edge of the top flanged end to the inlet for guiding an end of a tail piece into the inlet. The taper section may comprise at least one oval recess for further guiding an end of a tail piece into the inlet.

In one embodiment, the body includes gripping means on an exterior surface thereof for providing improved grip during installation. The gripping means may comprise a plurality of ridges.

In one embodiment, the seal is cylindrical. The seal may be disposed above the stop means. The seal may be provided with a plurality of internal cylindrical ribs for gripping the tail piece when the tail piece is inserted therein.

In one embodiment, the plumbing apparatus further comprises: a tail piece having a threaded end; and a nut operably connected to the threaded end for connecting the tail piece to a plumbing fixture.

In another aspect of the present invention, there is provided a method of using the plumbing apparatus to connect a fixture having a tail piece to a waste pipe. The method comprises: slipping the body on the waste pipe such that the waste pipe enters the channel via the outlet and is stopped by the stop means; mounting the plate to the top flanged end; mounting the plate to the floor above the waste pipe; positioning the fixture above the body and lowering the fixture such that the tail piece is guided into the inlet, through the seal, and at least partially into the waste pipe.

In one embodiment, the method of using the plumbing apparatus further comprises: applying an adhesive to the top end portion of the waste pipe and to the outlet prior to slipping the body on the waste pipe; and turning the body with respect to the waste pipe to evenly distribute the adhesive at a junction between the outlet and the top end portion of the waste pipe.

In yet another aspect of the present invention there is provided a method of manufacturing a plumbing apparatus for connecting a tail piece to a waste pipe. The method comprises: molding a main body with an internal cavity to receive both a seal and a retaining body; molding a retaining body having an internal cavity sized to fit and seat onto the top of a standard waste pipe, and having a stop ring at a top end thereof; applying a solvent based glue to an outside of the retaining body; sliding the retaining body into the cavity of the main body behind the seal; and holding the retaining body in position until the retaining body is solvent-welded to the main body.

### BRIEF DESCRIPTION OF THE DRAWINGS

FIG. 1 is a top-front perspective view of a plumbing apparatus for connecting a tail piece to a waste pipe, in accordance with an embodiment of the present invention;

FIG. 2 is a bottom-front perspective view of the plumbing apparatus of FIG. 1;

FIG. 3 is a top perspective view of the plumbing apparatus of FIG. 1;

FIG. 4 is a bottom perspective view of the plumbing apparatus of FIG. 1;

FIG. 5 is a front view of the plumbing apparatus of FIG. 1;

FIG. 6 is a side view of the plumbing apparatus of FIG. 1;

FIG. 7 is a top-front perspective view of the plumbing apparatus of FIG. 1 shown connected to a waste pipe;

FIG. 8 is a top-front perspective view of the plumbing apparatus of FIG. 1 shown connected to a waste pipe and a tail piece;

FIG. 9 is a cross-sectional view of the plumbing apparatus of FIG. 8;

FIG. 10 is a top perspective view of the a body of the plumbing apparatus of FIG. 1;

FIG. 11 is a bottom perspective view of the body of the plumbing apparatus of FIG. 1;

FIG. 12 is a side view of the body of the plumbing apparatus of FIG. 1;

FIG. 13 is a top view of the body of the plumbing apparatus of FIG. 1;

FIG. 14 is a sectional view of the body of the plumbing apparatus of FIG. 12;

FIG. 15 is a sectional view showing the body of the plumbing apparatus and the seal during manufacturing;

FIG. 16 is a perspective view of a seal which is part of the plumbing apparatus of FIG. 1;

FIG. 17 is a sectional view of the seal of FIG. 16 taken at lines 17-17; and

FIG. 18 is a top perspective view of the plate of the plumbing apparatus.

### DETAILED DESCRIPTION OF THE EMBODIMENT

As used herein, any usage of terms that suggest an absolute orientation (e.g. “top”, “bottom”, “front”, “back”, etc.) are for illustrative convenience and refer to a specific orientation. However, such terms are not to be construed in a limiting sense as it is contemplated that various components will, in practice, be utilized in orientations that are the same as, or different than those described or shown.

Referring to the attached figures, an apparatus 50 for connecting a fixture having a tail piece to a waste pipe is shown. It is to be understood that the apparatus 50 is purely exemplary and that it will become apparent to those skilled in the art that modifications to the apparatus 50 are contemplated. In the present embodiment, the apparatus 50 includes a body 55, a seal 60, and a plate 65. In another embodiment, the body 55 may be made of resilient material that a seal 60 may not be needed, as explained below.

The body 55 is generally cylindrical but other shapes may be contemplated. In one embodiment, body 55 has tapered external sidewalls from the top to the bottom. Body 55 has a longitudinal opening, passage, or channel formed therein and extending therethrough. The channel extends from an inlet 51 formed in a top flanged end 71 of body 55, to an opposite outlet 52 formed in a bottom end 77 of body 55. The body 55 is configured to receive a tail piece 100 at the inlet 51, and to connect to a waste pipe 110 at the outlet 52. In one embodiment, it is preferred that inlet 51 is sized to frictionally receive a tail pipe 100. Similarly, the outlet 52 preferably is sized to fit on a waste pipe, and hence the inner diameter of outlet 52 is preferably 1.5″ to fit on a standard waste pipe. Alternatively, the diameter of outlet 52 may be larger than 1.5″ but in this case a reduction ring would need to be used to fit onto a standard 1.5″ waste pipe. The body 55 is configured to secure a tail piece 100 and a waste pipe 110 to provide fluid communication between the tail piece 100 and the waste pipe 110. The manner by which the body 55 secures the tail piece 100 and the waste pipe 110 is not particularly limited. For example, the body 55 can secure the tail piece 100 and the waste pipe 110 using a friction fit. In particular, the body 55 can be made from a resilient material and the opening can be configured to be slightly smaller than external diameters of the tail piece 100 and the waste pipe 110 at the respective inlet 51 and outlet 52. It is to be understood by a person of skill in the art that the body 55 is not particularly limited to any material and that several types of materials are contemplated. The body 55 is typically made from materials suitable for waste water applications and that would be suitable resistant to degradation over time in such applications where the body 55 can be exposed to air, moisture, and a range of temperatures.

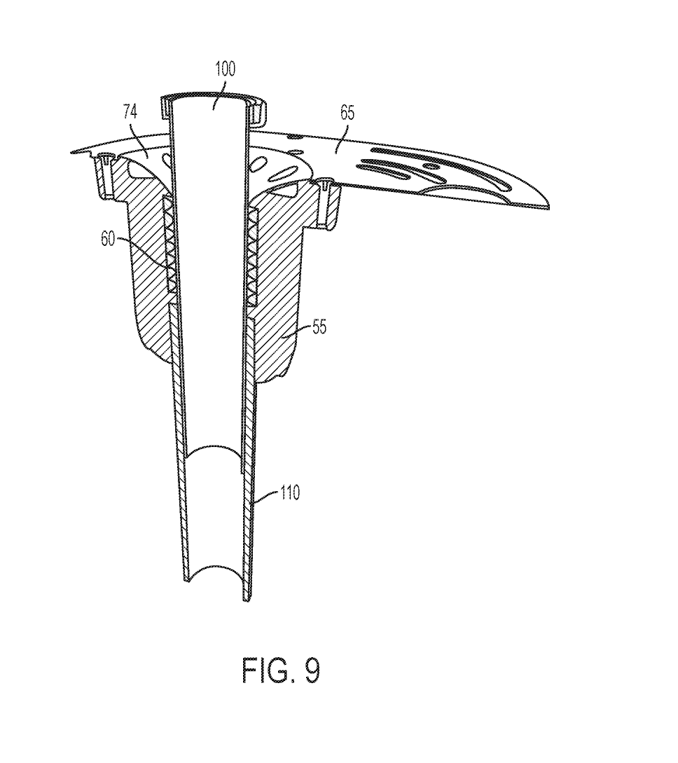

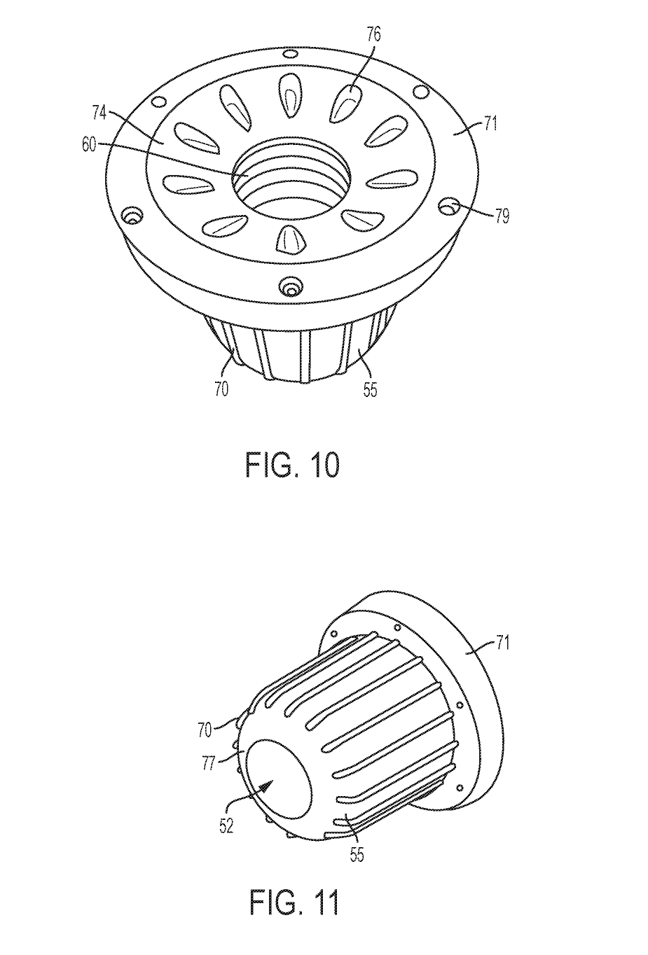

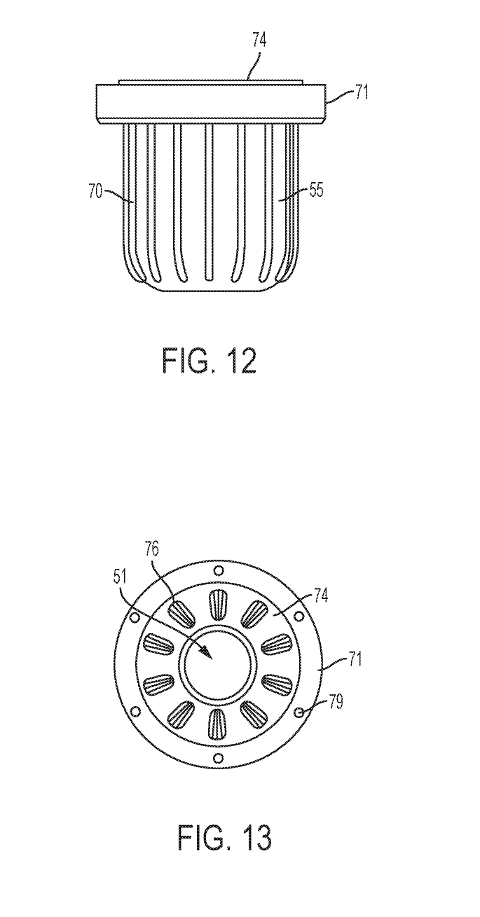

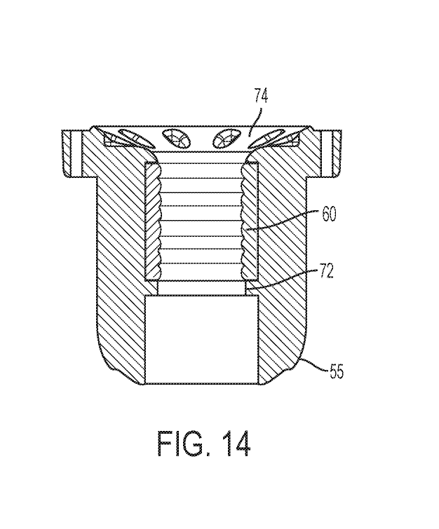

With specific reference to FIGS. 10-14, the body 55 of the present embodiment has a top flanged end 71 that, when installed, is substantially aligned with the floor surrounding the hole containing the waste pipe 110. The flanged end may extend radially outwardly to cover the floor hole containing the waste pipe. Alternatively, the top flanged end may be adapted to receive a plate which covers the floor hole. For example, top flanged end 71 may contain one or more holes 79 for receiving a fastener that secures a plate onto the top surface of top flanged end 71 thus covering the floor hole containing the waste pipe. In one embodiment, body 55 further includes a tapered section 74 at the top flanged end 71 of the body 55. As shown, the taper section 74 provides a slope from the outer edge of the top flanged end 71 of body 55 to the inlet 51. In the present embodiment, the slope angle of taper section 74 is about 10 degrees below the horizontal when the body 55 is oriented as shown in FIGS. 9 and 14. It is to be appreciated by a person of skill in the art that the taper section 74 is not particularly limited and can be greater or less than 10 degrees. For example, the angle can be anywhere in the range of 5 to 80 degrees. By increasing the angle of the taper section 74, the taper section 74 provides improved guidance of the end of the tail piece 110 through the inlet 51 at the cost of increasing the longitudinal length of the body 55. Taper section 74 may optionally contain oval recesses 76 which further guide the end of the tail piece 110 through the inlet 51. In one embodiment, as better seen in FIGS. 10, 12, and 14 taper section 74 is made higher than the top surface of flanged top end 71 by the thickness of the plate used to cover the floor hole such that the top surface of the plate aligns with the highest point of taper section 74.

In the present embodiment, the body 55 optionally includes gripping means in the form of a plurality of parallel ridges 70 on the exterior surface thereof. The ridges 70 extend longitudinally along the exterior surface of the body 55 and are generally configured to provide improved grip during installation over an existing waste pipe 110. The improved grip advantageous, since typically a quarter turn is required during that installation to evenly distribute the adhesive used at the junction between body 55 and waste pipe 110. It is to be appreciated by a person of skill in the art with the benefit of this description that the ridges 70 are not particularly limited and can be varied. For example, the ridges 70 can form a different pattern for providing improved grip, such as a diagonal or a cross pattern. In other embodiments, the ridges 70 can be omitted and the external surface of the body 55 can be treated with a substance having a high coefficient of friction. In other embodiments, the external surface of the body 55 can be smooth or rough with no additional features to improve grip.

With reference to FIG. 9 and FIG. 14, the body 55 can include a stop means for stopping waste pipe 110 at a particular point as it is inserted into the channel of body 55. This is preferred in embodiments where a seal is used within the channel. The stop means prevent damage to the seal from forces imparted thereon by the waste pipe 110 and the weight of the fixture transferred via body 55. As an example, the stop means may be a stop ring 72 formed at the interior walls of body 55 within the channel. The stop ring 72 is generally configured to position the body 55 relative to the waste pipe 110 by providing a stop when the body 55 is installed over the waste pipe 110. In the present embodiment, the stop ring 72 has the same height as the thickness of the waste pipe 110. It is to be appreciated by a person of skill in the art that by configuring the height of the stop ring 72 to be the same as the width of the waste pipe 110, the tail piece 100 can slide past the stop ring 72 and into the drain pipe 110 by about one inch when inserted from the inlet 51 of the channel of the body 55. However, it is to be appreciated that the amount the tail piece 100 is inserted into the waste pipe can be more or less. In other embodiments, the height of the stop ring 72 can be slightly greater than the width of the waste pipe 110 to provide a passage slightly smaller than the exterior diameter of the tail piece 100. By having the passage slightly smaller, a friction fit is provided when the tail piece 100 passes through the stop ring 72. It would be appreciated by a person of skill in the art that stop ring 72 is only a possible implementation of the stop means, and that other stop means are contemplated. For example, a plurality of radial tabs or pegs (not shown) extending radially inwardly from the inner wall of body 55 into the channel may also be used as a stop for waste pipe 100 within the channel.

Seal 60 is disposed within the body 55 and generally configured to seal the connection between the tail piece 100 and the waste pipe 110. The manner by which the seal 60 provides a seal is not particularly limited. In the present embodiment, the seal 60 is disposed above the stop ring 72 and has about the thickness as the height of the stop ring 72, and such that the inner diameter is about the same as or slightly smaller than the outer diameter of the tail piece 100. Therefore, the seal 60 can allow for the tail piece 100 to slide therethrough while maintaining contact to create a seal against the tail piece 100 to prevent waste water from leaking up the channel towards the inlet 51.

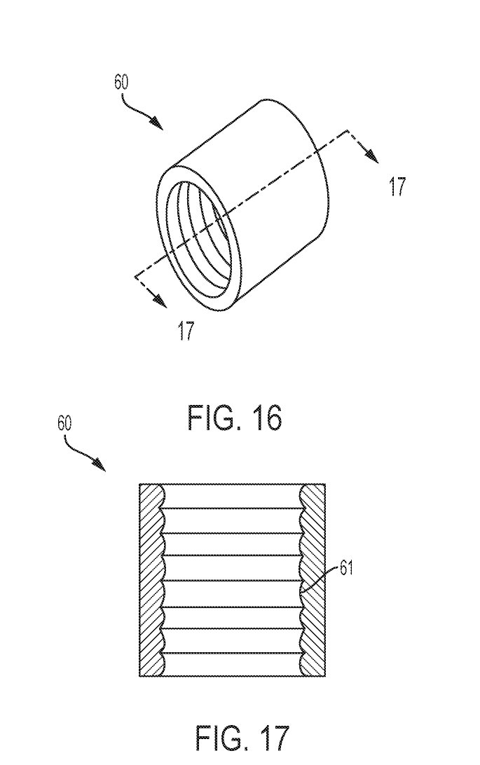

It is to be understood by a person of skill in the art that the seal 60 is not particularly limited to any material and that several types of materials are contemplated for creating a seal against the tail piece 100. In the present embodiment, the seal 60 is rubber. Some examples of other suitable materials include plastic, silicone and a number of other soft polymers. In the present embodiment, and referring to FIGS. 16 and 17, the seal 60 is cylindrical in shape and is provided with internal cylindrical ribs 61 for gripping the tail piece 100, when the tail piece is inserted therein. In other embodiments, the seal 60 can be modified or replaced with other sealing mechanisms. For example, the insert 60 can be replaced with a standard O-ring or other type of gasket. Alternatively, the tail piece 100 can be sealed using an adhesive or weld (subject to the materials that the body 55 and the tail piece 100 are made from).

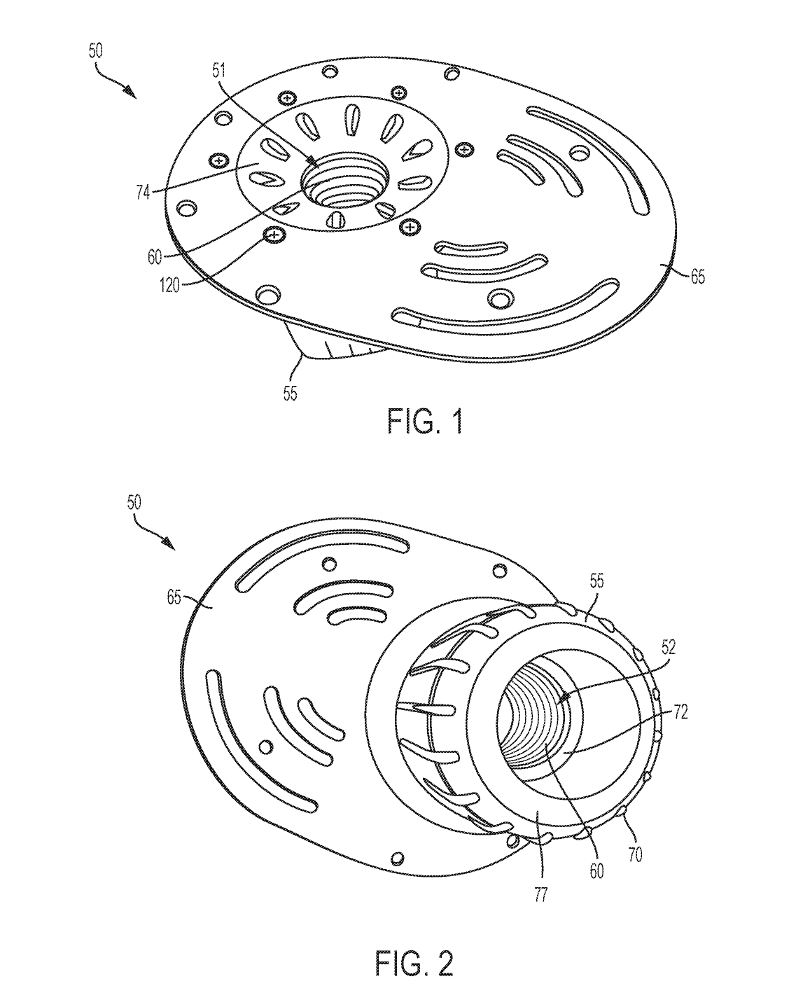

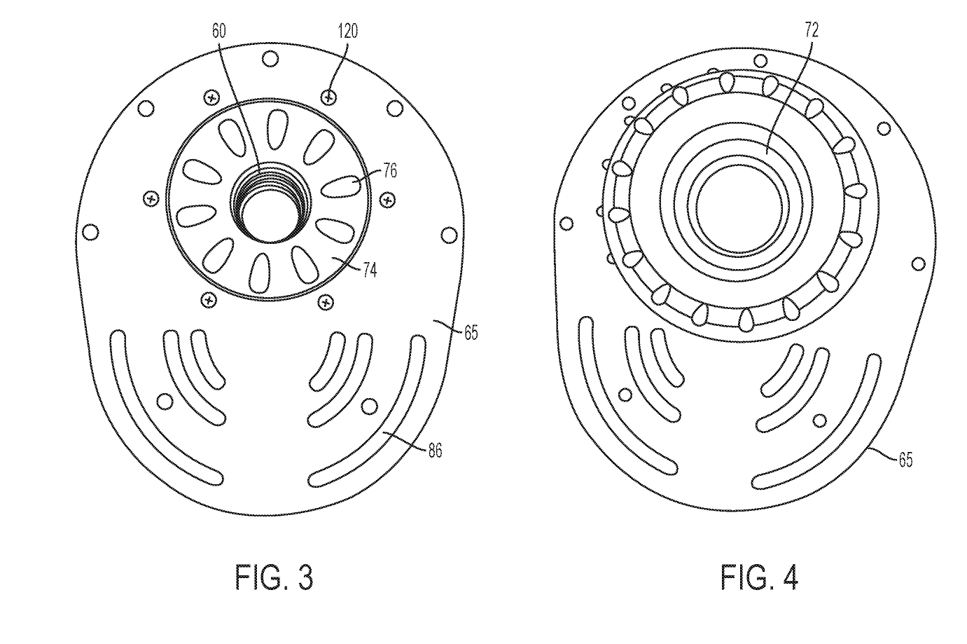

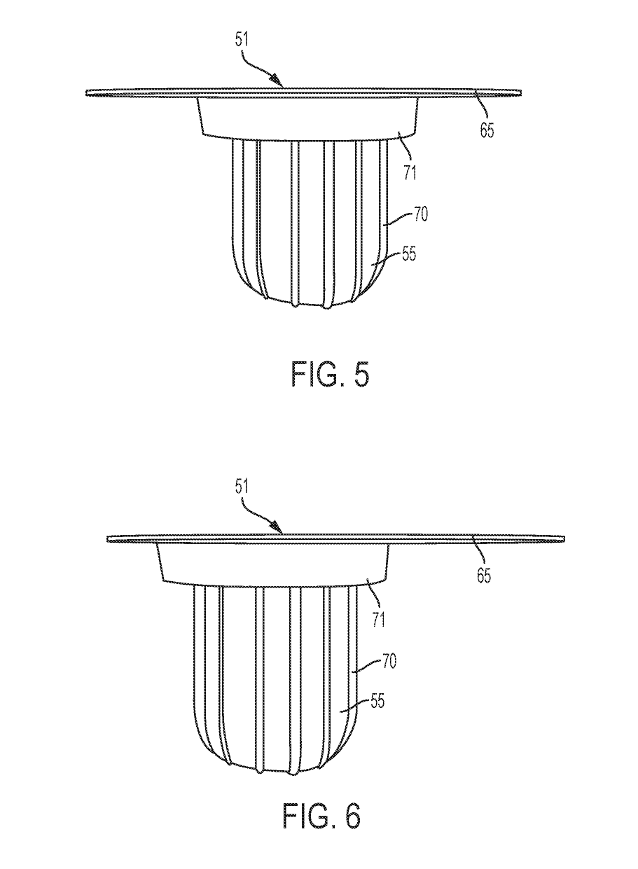

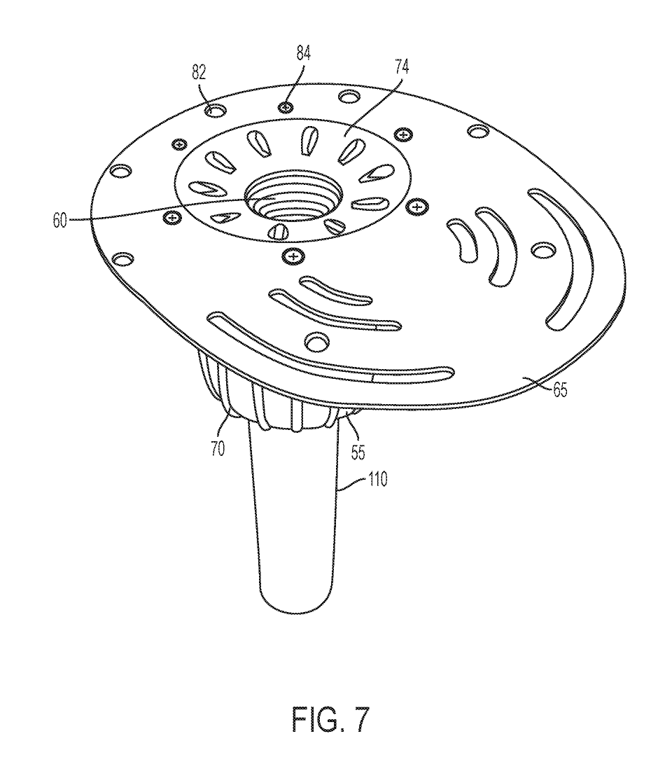

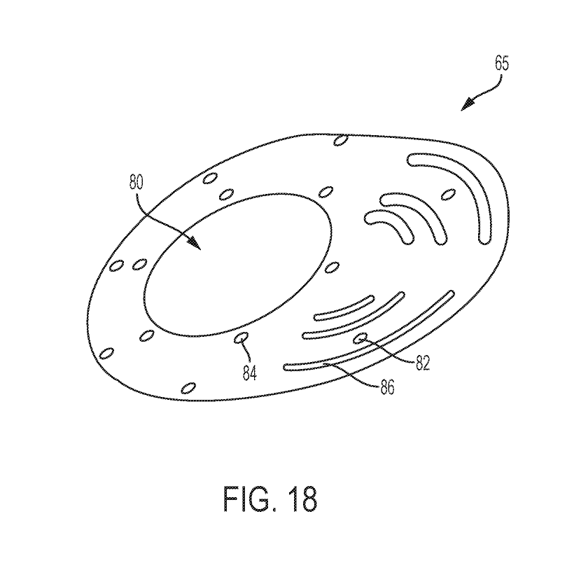

With reference to FIGS. 1-9 and 18, a plate 65 is connected to the body 55 and is generally configured to mount the apparatus 50 securely onto the floor over the waste pipe 110. It is to be understood by a person of skill in the art with the benefit of this description that the plate 65 is not particularly limited to any material and that several types of materials are contemplated for providing a rigid mount to the floor. In the present embodiment, the plate 65 is steel. In the present embodiment, the plate 65 can be optionally powder coated or otherwise treated to protect the plate 65 from rust or other damage. Some examples of other suitable materials include aluminum, brass, and plastic.

In the present embodiment, the plate 65 is oval or elliptical and includes an off-center opening 80 through which the body 55 may fit. The shape of the plate is not particularly limiting and it may be circular or have other shapes. The exact location of the off-center opening 80 with respect to the plate is not particularly limited and the amount that the off-center opening 80 is offset from the center of the plate 65 by can be varied. In the present embodiment, the center of the off-center opening 80 is about three inches away from the center of the plate 65. However, in other embodiments, the offset can be greater or less than three inches. By offsetting the opening 80 from the center of the plate 65, the plate 65 can be rotated to accommodate a waste pipe 110 that may not be centered in a hole on the floor. For example, if the waste pipe 110 is offset to the left of the hole in the floor, the plate 65 can be positioned such that the wider side of the plate covers the wider side of the hole in the floor created by the offset waste pipe 110. Similarly, if the hole in the floor is very close to a wall, the plate 65 may be oriented such that the narrower side from opening 80 to the edge of plate 65 may fit in the space between the hole in the floor and the wall. Advantageously, the off-center positioning of the opening 80 permits the accommodation of various floor hole configurations. In one embodiment, opening 80 is sized and shaped to fit around taper section 74. In other embodiments, opening 80 may be larger than section 74 or smaller overlapping an outer portion of section 74. In all embodiments opening 80 provides access to inlet 51 so that a tail piece may be inserted therein.

The plate 65 further includes a plurality of mounting holes 82 and body holes 84. The mounting holes 82 and body holes 84 are not particularly limited and are each generally configured to engage with a fastener. In the present embodiment, the mounting holes 82 and body holes 84 are all countersunk to provide a flat surface when mounted to the floor and/or the body 55. In other embodiments, the mounting holes 82 and body holes 84 can be simple holes drilled through the plate 65. The mounting holes 82 are generally configured to allow a fastener such as a screw or bolt to pass through and mount the apparatus 50 to the floor. The body holes 84 are generally configured to allow a fastener 120 such as a screw to pass therethrough and mount the plate 65 to the body 55 at top flanged end 71 when installing the apparatus 50. It is to be appreciated by a person of skill in the art with the benefit of this description that the mounting holes 82 and body holes 84 can include more or fewer holes than shown in the figures, and in some embodiments omitted completely. For example, in some embodiments, the body 55 can be connected to the plate 65 using other means such as adhesives or welds which would not require the body holes 84. However, the use of fasteners 120 is preferred so that the plate 65 is easily removable thus permitting post-installation maintenance or future replacement if required. For example, where a new fixture having a tail piece is to be installed in the future in place of the current fixture, the plumbing apparatus 50 may be removed and replaced with a new one suitable for receiving the new fixture. This is made possible since the large floor hole around the waste pipe 110 and the removable plate 65 both permit access to the waste pipe 110 beneath plumbing apparatus 50, thus allowing the waste pipe 110 to be cut and facilitating the easy removal of the plumbing apparatus 50.

The plate 65 also includes a plurality of slots 86, which can be used as an alternative method for mounting the plate 65 to the floor. For installations that involve pouring fresh concrete around the waste pipe 110, the plate 65 can be pressed into the wet concrete to be permanently mounted to the floor. As the plate 65 is pressed into the concrete, the slots 86 allow the concrete to pass therethrough to encase the plate 65 into the floor. It is to be appreciated by a person of skill in the art that the exact shape of the slots is not particularly limited. For example, the slots 86 can be modified to be a straight or zigzag pattern instead of being curved. In other embodiments, the slots 86 can be modified to be some other shape completely, such as a plurality of holes.

As an example of a variation, the plate 65 can be modified to omit the slots 86 or the mounting holes 82 to provide only a single option of mounting the plate 65 to the floor. As another variation, the pattern of the mounting holes 82 can be modified and spaced sufficiently far apart to also serve a function similar to the slots 86 such that separate slots 86 are not needed.

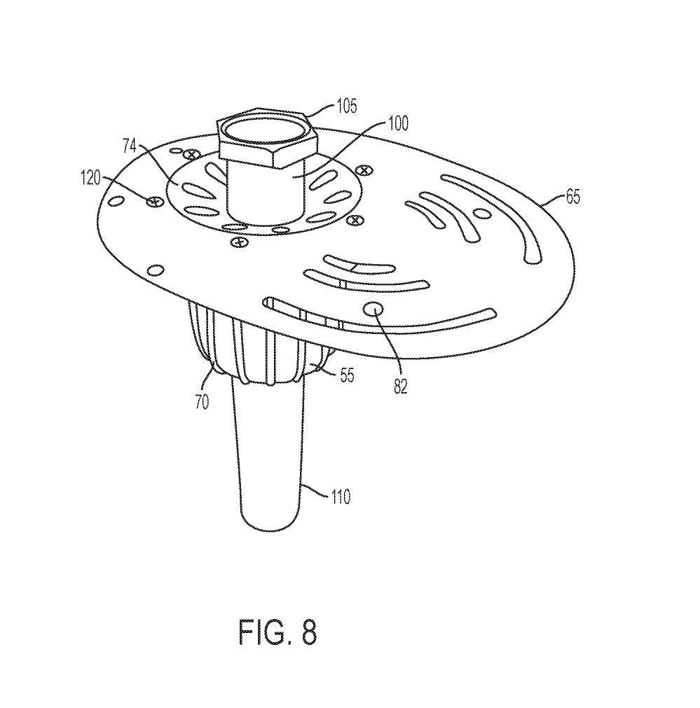

A tail piece 100 is typically connected to a plumbing fixture. For example, the tail piece 100 can be connected to the drain of a bath tub or other basin (not shown). It is to be appreciated by a person of skill in the art that the tail piece 100 is not particularly limited and can be part of the fixture or an additional part for connecting the fixture to the apparatus 50. In other embodiments, the tail piece 100 can be sold as part of a kit with the apparatus 50 and configured to connect with specific fixtures using various fastening means such as a threaded fastener or a weld. With reference to FIGS. 8 and 9, for example, tail piece 100 has a threaded portion and a nut 105 is coupled to the threaded portion so that the tailpiece 100 may be connected to any suitable plumbing fixture. It is to be understood by a person of skill in the art that the tail piece 100 is not particularly limited to any material and that several types of materials are contemplated. In the present embodiment, the tail piece 100 is brass. Some examples of other suitable materials include plastic, copper and other metals.

The waste pipe 110 is generally part of the network of pipes for removing waste water from a building. Accordingly, the waste pipe 110 is typically a polyvinyl chloride (PVC) pipe or acrylonitrile butadiene styrene (ABS) oriented vertically with an opening for receiving waste water. In general the waste pipe 110 ends in an opening on a floor that is larger in diameter than the diameter of the waste pipe 110.

In use, the present embodiment of the apparatus 50 allows for fast and easy installation of various plumbing fixtures over a waste pipe 110 in a hole on the floor. First, the body 55 is installed over the waste pipe 110. The manner by which the body 55 is installed is not particularly limited. In the present embodiment the body 55 is slipped over the waste pipe 110 such that the waste pipe 110 enters the channel of body 55 via outlet 52. In one embodiment, where a seal 60 is disposed above stop ring 72, the waste pipe 110 abuts against the stop ring 72. In another embodiment, where no seal 60 is present, waste pipe 110 extends through the channel until it abuts a bottom of the top flanged end 71. As is known in the art, an appropriate adhesive is applied at the junction between the outlet 52 of body 55 and the waste pipe 110. Also, as is known in the art, the body 55 is given a quarter-turn relative to the waste pipe 110 to evenly distribute the adhesive at the junction. Next, the plate 65 is connected to the body 55 using fasteners 120 through the body holes 84. The plate 65 is then mounted to the floor, using fasteners through mounting holes 82, in a suitable position and with a suitable orientation depending on the position of the hole in the floor as explained above.

The tail piece 100 may then be connected to the drain of the plumbing fixture. For example, if the tail piece has a threaded portion and nut 105 as described above then the tail piece may be connected to the drain of the fixture using nut 105. The plumbing fixture is then positioned over the floor hole containing the waste pipe 110. The plumbing fixture is then lowered towards the body 55 such that the tail piece 100 is guided into the inlet 51 by the taper section 74 to complete the installation of the plumbing fixture using the apparatus 50. Advantageously, the apparatus 50 allows for connecting a fixture having a tail piece 100 to a waste pipe 110 where no tightening of any members below the floor is necessary. This alleviates the need to damage the ceiling below the waste pipe from underneath to be able to access a nut or a fastener to tighten the seal between the tail piece 100 and the waste pipe 101.

It is to be appreciated by a person of skill in the art that the apparatus 50 can also be sold as a kit of parts for assembly described above or in a semi-assembled state. For example, apparatus 50, the tail piece 100 and nut 105 which fits on a threaded top end of tail piece 100, may be sold together as a kit which may fit a number of plumbing fixtures such as bathtubs, basins and showers.

It is to be re-emphasized that the structures described herein are non-limiting representations only. In particular, it is to be understood that various features of the embodiments described herein can be combined, modified, or omitted. For example, it is to be appreciated by a person of skill in the art with the benefit of this description that the seal 60 can be omitted in embodiments where the channel of body 55 is sized to form a sufficient seal with the tail piece 100 at the inlet 51, and the body 55 is made with a sufficiently resilient material.

Various advantages will now be apparent to a person of skill in the art. Of note is the ability to install plumbing fixtures quickly and efficiently with few parts. For example, by using a single unitary body 55 to connect the fixture to the waste pipe 110, the installation of the fixture becomes easier and the cost of manufacturing the apparatus is reduced. Additionally, the single unitary body 55 does not require access from below to secure and seal the connection between the tail piece 100 and the waste pipe 110 thus making it suitable for installing a variety of fixtures in already built homes. The oval shape and off-center positioning of the body with respect to the plate is suitable for use with island tubs, retrofit tubs, and claw foot tubs. Another example of an advantage is that the plate 65 can accommodate off-center waste pipes 110 which reduces the cost of labor involved in such installations. For example, if a conventional plate with a central opening were used, an off-center waste pipe 110 would need to be re-centered in the floor opening which may require additional construction work.

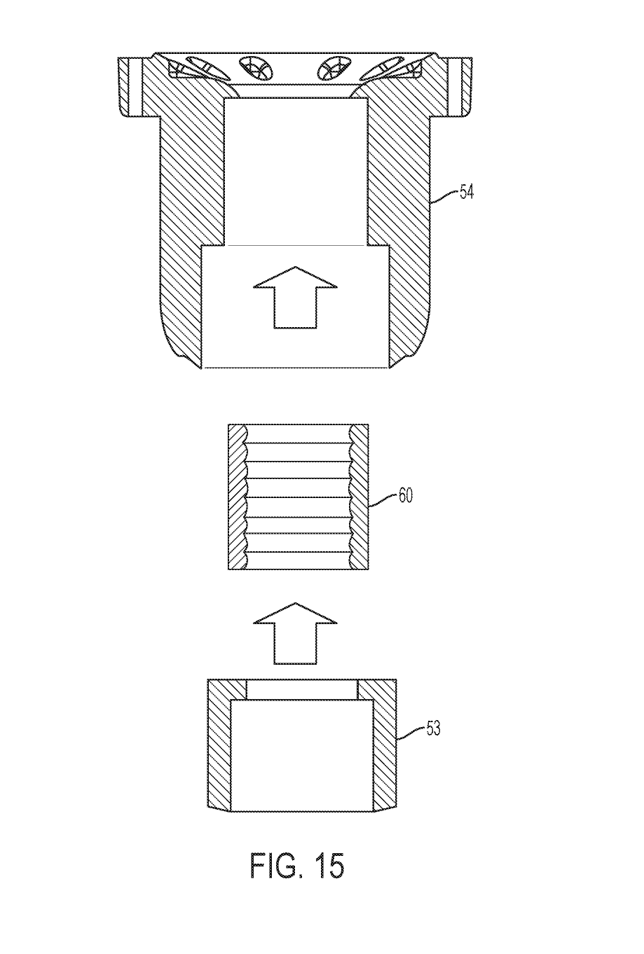

To manufacture the body 55 of apparatus 50, the following steps are carried out with reference to FIG. 15. A main body 54 is molded with an internal cavity to receive both a seal 60 and then a retaining body 53 featuring stop ring 72. The interior of the retaining body 53, below stop ring 72, is sized to fit and seat onto the top of a standard waste pipe 110, which is typically 1.5″ in diameter. First the seal 60 is inserted into the cavity of the main body 54. A solvent based glue is applied to the outside of the retaining body 53 which is then slid into the cavity of the main body 54 behind the seal 60 and held in position until the retaining body 53 is solvent-welded to the main body 54. At this point the apparatus body 55 assembly becomes a single part that cannot be disassembled without causing damage to the components.

In one embodiment, the retaining body 53, is inserted without solvent based glue, and is frictionally engaged within the cavity of the main body 54 due to the interaction between the outer surface of the retaining body 53 and the inner surface of the cavity in the main body 54. The friction between these surfaces is sufficient to retain the retaining body 53 in position when the unit is oriented as shown in FIG. 15. However, when the part leaves the factory, the retaining ring 53 will have been solvent-welded into the cavity in the main body 54. Advantageously, as body 55 is assembled into a single part, this prevents leakage therefrom, alleviates the need to tighten the part after installation which is not possible where bottom access to the apparatus 50 is not available without damaging the ceiling below the waste pipe. Additionally, there is no possible relative rotational movement between retaining body 53 and main body 54, thus installation which includes a quarter turn of the apparatus relative to a waste pipe is facilitated.

While specific embodiments have been described and illustrated, such embodiments should be considered illustrative only and should not serve to limit the accompanying claims.

What is claimed is:

1. A plumbing apparatus for connecting a tail piece to a waste pipe, comprising:
a body having:
a top flanged end having an inlet configured for receiving the tail piece; and
a bottom end having an outlet opposite the inlet, the outlet configured for receiving the waste pipe;
the body having a channel formed by an inner wall thereof, the channel extending between the inlet and the outlet;
a seal extending about the channel for forming a watertight seal between the tail piece and the waste pipe when the tail piece is inserted through the inlet and into the waste pipe; and
stop means disposed at the inner wall for stopping the waste pipe when the waste pipe is inserted into the channel via the outlet.

2. The plumbing apparatus according to claim 1, wherein the stop means comprises a stop ring.

3. The plumbing apparatus according to claim 1, further comprising a plate secured to the top flanged end for mounting the plumbing apparatus to a floor over the waste pipe, the plate having an opening surrounding at least a portion of the top flanged end and providing access to the inlet so that the tail piece may be inserted into the inlet.

4. The plumbing apparatus according to claim 3, wherein the plate is removably secured to the top flanged end.

5. The plumbing apparatus according to claim 3, wherein the opening is located off-center with respect to the plate.

6. The plumbing apparatus according to claim 3, wherein the plate is oval in shape.

7. The plumbing apparatus according to claim 3, wherein the plate contains at least one slot for permitting wet concrete therethrough for securing the plate onto a floor.

8. The plumbing apparatus according to claim 4, wherein the plate contains at least one body hole for receiving a fastener to secure the plate to the top flanged end.

9. The plumbing apparatus according to claim 4, wherein the plate contains at least one mounting hole for receiving a fastener to secure the plate to the floor over the waste pipe.

10. The plumbing apparatus according to claim 1, wherein the top flanged end comprises a taper section providing a slope from an outer edge of the top flanged end to the inlet for guiding an end of a tail piece into the inlet.

11. The plumbing apparatus according to claim 10, wherein the taper section comprises at least one oval recess for further guiding an end of a tail piece into the inlet.

12. The plumbing apparatus according to claim 1, wherein the body includes gripping means on an exterior surface thereof for providing improved grip during installation.

13. The plumbing apparatus according to claim 12, wherein the gripping means comprise a plurality of ridges.

14. The plumbing apparatus according to claim 1, wherein the seal is cylindrical.

15. The plumbing apparatus according to claim 1, wherein the seal is disposed above the stop means.

16. The plumbing apparatus according to claim 14, wherein the seal is provided with a plurality of internal cylindrical ribs for gripping the tail piece when the tail piece is inserted therein.

17. The plumbing apparatus according to claim 1, further comprising:
a tail piece having a threaded end; and
a nut operably connected to the threaded end for connecting the tail piece to a plumbing fixture.

18. A method of using the plumbing apparatus of claim 3 to connect a fixture having a tail piece to a waste pipe, the method comprising:
slipping the body on the waste pipe such that the waste pipe enters the channel via the outlet and is stopped by the stop means;
mounting the plate to the top flanged end;
mounting the plate to the floor above the waste pipe;
positioning the fixture above the body and lowering the fixture such that the tail piece is guided into the inlet, through the seal, and at least partially into the waste pipe.

19. The method of using the plumbing apparatus of claim 3, further comprising:
applying an adhesive to the top end portion of the waste pipe and to the outlet prior to slipping the body on the waste pipe; and
turning the body with respect to the waste pipe to evenly distribute the adhesive at a junction between the outlet and the top end portion of the waste pipe.

20. A method of manufacturing a plumbing apparatus for connecting a tail piece to a waste pipe, the method comprising:
molding a main body with an internal cavity to receive both a seal and a retaining body;
molding a retaining body having an internal cavity sized to fit and seat onto the top of a standard waste pipe, and having a stop ring at a top end thereof;
applying a solvent based glue to an outside of the retaining body;
sliding the retaining body into the cavity of the main body behind the seal; and
holding the retaining body in position until the retaining body is solvent-welded to the main body.
